(19) United States
(12) Patent Application Publication
(10) Pub. No.: US 2012/0088886 A1
(43) Pub. Date: Apr. 12, 2012

(54) PROCESSES FOR THE PREPARATION OF SEVELAMER CARBONATE

(75) Inventors: Ravindra Krishnarao Burde, Maharashtra (IN); Ashutosh Joshi, Maharashtra (IN); Manjunath Narayan Bhanu, Maharashtra (IN)

(73) Assignee: WATSON PHARMA PRIVATE LIMITED, Andheri (East),Mumbai,Maharashtra (IN)

(21) Appl. No.: 13/377,433

(22) PCT Filed: Jun. 16, 2010
(86) PCT No.: PCT/IN10/00413

§ 371 Date: Dec. 9, 2011

(30) Foreign Application Priority Data
Jun. 16, 2009 (IN) 1440/MUM/2009

(51) Int. Cl. C08F 26/02; C08F 8/18

(52) U.S. Cl. 525/359.2; 525/355

(57) ABSTRACT

Processes for preparing Sevelamer Hydrochloride and Sevelamer Carbonate are described.

### CROSS-REFERENCE TO RELATED APPLICATIONS

This application claims the priority of Indian Patent Application No. 1440/MUM/2009, filed Jun. 16, 2009, which is incorporated herein by reference.

### FIELD OF THE INVENTION

The present invention relates to processes for preparing Sevelamer Carbonate.

### BACKGROUND OF THE INVENTION:

The synthesis of Sevelamer as a phosphate binding polymer is disclosed in U.S. Patent No. 5,496,545. Sevelamer Carbonate, chemically known as Prop-2-en-1-amine polymer with (chloromethyl)oxirane carbonate, is a cross-linked polymer that can be prepared by cross-linking polyallylamine hydrochloride with Epichlorohydrin as cross-linking agent. It has found many therapeutic applications in medicine.

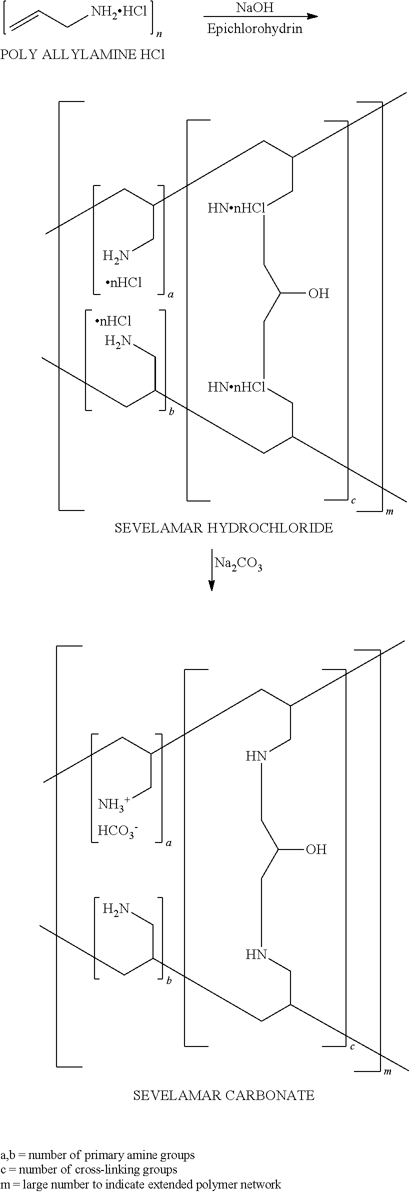

U.S. Pat. No. 5,496,545 discloses the use of phosphate binding polymers for removing phosphate from the gastrointestinal tract. The polymers are orally administered, and useful for the treatment of hyperphosphatemia. U.S. Pat. No. 5,496,545 also describes a process for preparing cross-linked polymers of polyallylamine hydrochloride (Sevelamer Hydrochloride). The cross-linked polymer gel is allowed to cure for 18 hrs and fragmented in a blender in presence of isopropanol. The polymer is washed successively with water and finally with isopropanol. The polymer is then dried in a vacuum oven for 18 hrs. The patent also discloses the spectrophotometric phosphate assay of Sevelamer Hydrochloride.

The synthesis of polyallylamine hydrochloride polymer and the cross-linking agents used for cross-linking polyallylamine hydrochloride are disclosed in U.S. Pat. Nos. 4,605,701; 5,496,545; 5667,775 and 6,083,495.

U.S. Pat. No. 5,496,545 discloses that polyallylamine hydrochloride solution is initially partially neutralized by using a base at ambient temperature followed by addition of a cross-linking agent to obtain a gel. The gel is then allowed to cure overnight to obtain cross-linked polyallylamine hydrochloride.

U.S. Pat. No. 6,600,011 describes a spray drying technique for the drying of cross-linked polyallylamine polymer. The patent claims that damage to the shear sensitive polymer gel can be avoided by using spray drying, which also enables control over particle size. It also describes the use of a Ystral three stage disperser to achieve desired particle size.

Published PCT patent application WO 01/18073 A1 discloses a process for producing a cross-linked polyallylamine polymer having reduced cohesiveness from an aqueous solution of a washed cross-linked polyallylamine polymer treated with a surfactant. A process for preparing cross-linked polyallylamine polymer compositions is also disclosed in the patent.

U.S. Pat. No. 6,362,266 describes the use of specific equipment, a LIST-Discotherm B reactor, to process high viscosity materials. In this case, the equipment breaks the gel into smaller pieces. It also discloses the use of ion-exchange, dialysis, nanofiltration or ultrafiltration to remove inorganic salts from the polymer, which would otherwise be removed by washing with water.

U.S. Pat. No. 6,525,113 describes a process for preparation of cross-linked polymers by mixing polyallylamine, water, base and acetonitrile followed by addition of cross-linking agent.

U.S. Pat. No. 7,388,056 describes a process for preparing cross-linked polymers wherein the aqueous solution of partially neutralized polyallylamine hydrochloride solution and epichlorohydrin is dispersed in an organic medium containing surfactant.

Published PCT patent application WO2008/062437 discloses a process for preparing Sevelamer Hydrochloride having phosphate binding capacity of (PBC) 4.7-6.3 mmol/g. This application also discloses Sevelamer Hydrochloride compositions and a process for preparing said compositions comprising a high shear non-aqueous granulation.

These prior art processes for preparation of Sevelamer Hydrochloride require specialized equipment and operations that are more difficult to scale-up.

Thus there is a need to develop processes for preparing Sevelamer Hydrochloride as well as Sevelamer Carbonate which will be easy to operate on a larger scale, does not need specialized equipment, and/or is more cost effective.

### SUMMARY OF THE INVENTION

The present invention provides a process for preparation of Sevelamer Carbonate, preferably having phosphate binding capacity of 5.0-7.0 mmol/g.

The process preferably comprises a one pot reaction of adding a cross-linking agent to a solution of partially neutralized polyallylamine hydrochloride, obtaining a gel, curing the gel, washing the gel and treating the wet gel with alkali or alkaline earth metal carbonates, washing the product and finally drying the product to obtain Sevelamer Carbonate.

In one embodiment, the present invention provides an in-situ process for preparing Sevelamer Carbonate from Sevelamer Hydrochloride without the isolation and drying of the latter. The preferred process of the present invention is easy, simple and facile to operate on a larger scale.

The issue of filtration of the gel is preferably resolved on a large scale by using specific filtration media having a mean pore size of 20-30 microns.

### DETAILED DESCRIPTION OF THE INVENTION

A preferred embodiment of the present invention is one that provides a simple, efficient and easily scaleable process for the preparation of Sevelamer Carbonate. Another preferred embodiment is Sevelamer Carbonate having phosphate binding capacity of 5.0-7.0 mmol/g and/or pH between 8.0-11.0.

In a preferred embodiment, water is removed from the wet gel of Sevelamer Carbonate by azeotropic distillation using solvents which form azeotropes with water.

Another embodiment is a process that does not involve removal of water by water miscible solvents from Sevelamer Carbonate. Drying of the wet gel can be done by drying the product in an Air tray Dryer or Fluidized Bed Dryer.

Another embodiment is a process for in-situ conversion of Sevelamer Hydrochloride to Sevelamer Carbonate without isolation.

The present invention preferably provides a simple, easy and industrially scaleable process for preparation of Sevelamer Carbonate. In a preferred embodiment, the process comprises:
i) partially neutralizing a solution of polyallylamine hydrochloride with a base;
ii) adding predetermined quantity of epichlorohydrin to the solution of partially neutralized polyallylamine hydrochloride solution to obtain a gel;
iii) curing the gel;
iv) treating the gel with a water miscible solvent, followed by water to obtain wet Sevelamer Hydrochloride;
v) subjecting the wet Sevelamer Hydrochloride to anion exchange by suspending it in a solution of suitable alkali or alkaline earth metal carbonates for specific time period;
vi) washing the Sevelamer Carbonate with water; and
vii) drying the wet product between 30-105° C. in Air tray dryer or fluidized bed dryer to obtain Sevelamer Carbonate having phosphate binding capacity of 5.0-7.0 mmol/g and pH between 8.0-11.0.

In one embodiment sevelamer carbonate is prepared by obtaining a partially neutralized solution of polyallylamine hydrochloride, typically having a pH of about 10 to about 11, about 10.0 to about 11.0, about 10.0 to about 10.5, or about 10.0 to about 10.2. The concentration of the polyallylamine hydrochloride solution is preferably about 15-30%, 15-25%, or 20-25% w/w. The pH of the polyallylamine hydrochloride solution is preferably adjusted using sodium hydroxide and/or potassium hydroxide, typically in the form of a 25-60% solution, e.g., 40-50%.

Epichlorohydrin is admixed with the solution of polyallylamine hydrochloride to form sevelamer hydrochloride. Epichlorohydrin is preferably about 5-15%, about 7-12% or about 8-10% w/w of polyallylamine hydrochloride.

The sevelamer hydrochloride is allowed to cure and form a gel. Typically, curing takes about 16-36, about 18-30, or about 16-18 hours.

The gel is preferably washed, preferably with a water-miscible solvent, followed by water, to obtain wet sevelamer hydrochloride. Preferred water-miscible solvents comprise at least one alcohol, preferably consisting essentially of one or more alcohols, such as methanol, isopropanol, or a combination thereof. Other water-miscible solvents are well known in the art; however, ketones are disfavored. In one embodiment, the gel can be broken into pieces (e.g., by using a scraper) prior to washing.

The sevelamer hydrochloride preferably undergoes an anion exchange with an alkali or alkaline earth metal carbonate to form sevelamer carbonate. Preferably, the carbonate is ammonium carbonate, sodium carbonate, potassium carbonate, lithium carbonate, and/or cesium carbonate. Sodium carbonate or potassium carbonate is preferred. The concentration of carbonate solution used is preferably about 0.2-2.3 M or about 0.5-2.0 M. The contact time of wet product with carbonate solution is preferably about 2-18, 2-8, or 2-4 h.

Preferably, the sevelamer carbonate is washed in an aqueous solution. Washing can be performed, for example, in a SS-316 reactor (or equivalent thereof), preferably having a stirring speed of about 40-170, about 50-125 or about 60-100 rpm. Filtration of the product can be done, for example, using a Neutsch-type filter, agitated Neutsch-type filter or centrifuge. Centrifugation of the product can be done, for example, using a centrifuge bag of about 5-30 micron or about 20-25 micron.

Preferably, the sevelamer carbonate is dried, preferably in an air tray dryer or a fluidized bed dryer. Preferably, the drying temperature is about 30-105 ° C. or about 80-100° C. The wet material can be optionally milled after a predetermined period of drying and then returned to drying. The above cycle of drying and milling can be repeated 2-3 times during the course of drying. Similarly, optionally, wet sevelamer hydrochloride can be dried using the technique of processing and drying described above.

Preferably, the sevelamer carbonate is milled to achieve a d₉₀ particle size of less than 100 microns.

In one embodiment, washing of the gel can be performed in an SS-316 reactor (or equivalent thereof) having stirring speed of 40-170 revolutions per min (rpm), preferably between 50-125 rpm, most preferably between 50-80 rpm.

In one embodiment, sevelamer hydrochloride is washed with solvent followed by water and filtered using a Neutsch-type filter, agitated Neutsch-type filter or a centrifuge. The most preferred mode of filtration is by centrifuge. Centrifugation of the product is preferably done using a centrifuge bag of about 5-30, about 5-20, or about 20-25 micron.

In one embodiment, the wet sevelamer carbonate is stirred with solvents capable of forming an azeotrope with water, such as alcohols, ketones, hydrocarbons and chlorinated solvents. Preferred solvents are toluene and methylene chloride.

Sevelamer Hydrochloride obtained according to processes of the present invention preferably has a chloride content of about 12-17% w/w and/or a phosphate binding capacity of about 5-7 or about 5.0-7.0 mmol/g.

Sevelamer Carbonate obtained according to the process of the present invention preferably has a chloride content of less than about 2% w/w, less than about 1%, or than about 0.5% w/w.

Preferably, the obtained sevelamer carbonate has a phosphate binding capacity of about 3-7, about 5-7, or about 5.0-7.0 mmol/g. Preferably the pH is about 8-11 or about 8.0-11.0 in a 1% solution.

LOD (Loss on drying) of Sevelamer Carbonate obtained according to the above processes is preferably not more than (NMT) 7% w/w or below 5% w/w.

The following examples illustrate various aspects of the present invention.

### Example 1

### Preparation of Wet Crude Sevelamer Hydrochloride

To 70 kg of polyallylamine hydrochloride (−50% w/w solution), 105 liter of DM water was added. The pH of the solution was adjusted to 10.3 using 50% sodium hydroxide solution at 25-30° C. 3.5L of epichlorohydrin was added to the mass and stirred for 10 min. The mass was then drained in stainless steel (SS) containers and allowed to cure for 18 hrs. The gel was then broken into pieces. 140 liters of isopropanol was taken in a stainless steel reactor and the gel pieces were added to it. The mass was then stirred for 1 hrs at 45-60 rpm. It was then centrifuged using a centrifuge bag of 25 micron. The centrifuged mass was again added to the reactor containing 560 liters of water and stirred for 1 hrs at 45-60 rpm. The product was again centrifuged. The above process was again repeated twice using 560 liters of water each time. Product was then centrifuged and spin dried at 300-400 rpm.

Wet cake of the gel=420 kg.

### Example 2

### Preparation of Wet Crude Sevelamer Carbonate

Wet gel 140 kg obtained from Example 1 was suspended in a solution of sodium carbonate (15 kg dissolved in 60.0 liter of water) and stirred for 2 hrs at 45-60 rpm. It was then centrifuged using a centrifuge bag of 5 micron. The centrifuged mass was again added to the reactor containing 280 liters of water and stirred for 1 hrs at 45-60 rpm. The product was again centrifuged. The above process was repeated thrice using 280 liters of water each time. The product was then centrifuged and spin dried at 500-600 rpm of centrifuge speed.

Wet cake=52.7 kg

### Example 3

### Drying of Sevelamer Carbonate

A wet cake obtained by following the process described in Example 2 was dried directly in an air tray drier at 100° C. Product was unloaded after the desired LOD was achieved. Product was then micronized by using an air jet mill.

Sulfated ash=0.07%; pH=8.76; Chloride content=nil; PBC=6.8 mmol/g

The present invention has been particularly described, in conjunction with specific preferred embodiments and it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A process for preparing sevelamer carbonate comprising:
a) providing a solution of polyallylamine hydrochloride having a pH of about 10 to about 11;
b) admixing epichlorohydrin with the solution of polyallylamine hydrochloride;
c) curing of the solution to form a gel;
d) treating the gel with a water-miscible solvent, followed by water, to obtain wet sevelamer hydrochloride;
e) treating the wet sevelamer hydrochloride with a solution comprising an alkali or alkaline earth metal carbonate; and
f) drying the wet product of step (e) to obtain sevelamer carbonate.

2. The process of claim 1, wherein the curing step takes about 18-30 hours.

3. The process of claim 1, further comprising washing the sevelamer carbonate obtained in step (e) with an aqueous solution.

4. The process of claim 1, wherein step (f) comprises drying the wet product at between 30-105° C. in an air tray dryer or fluidized bed dryer.

5. The process of claim 1, wherein the product of step (f) has a pH of about 8-11 in a 1% solution.

6. The process of claim 1, further comprising milling the product of step (f) to achieve a d₉₀ particle size of less than 100 microns.

7. The process of claim 1, wherein the obtained sevelamer carbonate has a phosphate binding capacity of about 3 to about 7 mmol/g.

8. The process of claim 7, wherein the obtained sevelamer carbonate has a phosphate binding capacity of about 5 to about 7 mmol/g.

9. The process of claim 7, wherein the obtained sevelamer carbonate has a phosphate binding capacity of about 5.0 to about 7.0 mmol/g.

10. The process of claim 1, wherein the solution of polyallylamine hydrochloride has a pH of about 10.0 to about 10.5.

11. The process of claim 1, wherein the water-miscible solvent contains at least one alcohol.

12. The process of claim 11, wherein the water-miscible solvent is selected from the group consisting of methanol, isopropanol, and mixtures thereof.

13. A process for preparing sevelamer carbonate comprising:
a) providing wet sevelamer hydrochloride;
b) treating the wet sevelamer hydrochloride with a solution comprising an alkali or alkaline earth metal carbonate; and
c) drying the wet product of step (b) to obtain sevelamer carbonate.

14. The process of claim 13, wherein the obtained sevelamer carbonate has a phosphate binding capacity of about 3 to about 7 mmol/g.

15. A process for preparation of sevelamer carbonate having phosphate binding capacity of 5.0-7.0 mmol/g comprising:
a) partially neutralizing a solution of polyallylamine hydrochloride by adjusting the pH to between 10.0 to 10.5 with a base;
b) adding epichlorohydrin to the solution of polyallylamine hydrochloride solution at pH between 10.0 to 10.5;
c) curing of the gel for 18-30 hrs;
d) treating the gel with a water miscible alcoholic solvent, followed by water to obtain wet sevelamer hydrochloride;
e) treating the wet sevelamer hydrochloride with a solution comprising an alkali or alkaline earth metal carbonate;
f) washing the sevelamer carbonate so obtained with water;
g) drying the wet product at between 30-105° C. in an air tray dryer or fluidized bed drier to obtain sevelamer carbonate having phosphate binding capacity of 5.0-7.0 mmol/g and a pH of between 8.0-11.0 in a 1% solution; and
h) milling the dried material in an air jet mill to achieve a d₉₀ particle size of less than 100 microns.

16. The process of claim 1, wherein the concentration of the polyallylamine solution is about 15-30% w/w.

17. The process of claim 1, wherein the pH of the polyallylamine solution is adjusted using sodium hydroxide or potassium hydroxide.

18. The process of claim 1, wherein concentration of base is about 25-60%.

19. The process of claim 1, wherein the treating steps are performed in a reactor having stirring speed of 40-170 rpm.

20. The process of claim 1, further comprising at least one filtration step using a Neutsch-type filter, agitated Neutsch-type filter or a centrifuge.

21. The process of claim 1, wherein the alkali or alkaline earth metal carbonate is sodium carbonate or potassium carbonate.

22. The process of claim 15, wherein a filtration step is done with a centrifuge using centrifuge bag of 20-25 micron.

23. The process of claim 15, wherein a filtration step is done with a centrifuge using centrifuge bag of 5-20 microns.

24. The process of claim 1, wherein the drying step is done using an air tray dryer.

25. The process of claim 1, wherein the sevelamer carbonate obtained has a chloride content of less than about 0.5%.

26. The process of claim 1, wherein the sevelamer carbonate obtained has a phosphate binding capacity of 5.0-7.0 mmol/g and a pH of about 8 to about 11 when in a 1% solution.

27. The process of claim 1, wherein the sevelamer carbonate is micronized with an air jet mill to achieve particle size of d₉₀ less than 100 microns.

28. The process of claim 16, wherein the concentration of the polyallylamine solution is about 15-25%.

29. The process of claim 16, wherein the concentration of the polyallylamine solution is about 20-25%.

30. The process of claim 18, wherein concentration of base is about 40-50% w/w.

31. The process of claim 10, wherein the pH of the polyallylamine solution is adjusted to between about 10.0-10.2.

32. The process of claim 19, wherein the treating steps are performed in a reactor having stirring speed of between 50-80 rpm.

33. The process of claim 1, wherein the process is an in-situ process.

34. The process of claim 1, wherein the process is suitable for large-scale production of sevelamer carbonate.

35. A process for preparing sevelamer carbonate comprising:
combining a partially neutralized solution of polyallylamine hydrochloride with epichlorohydrin to form sevelamer hydrochloride;
allowing the sevelamer hydrochloride to gel;
optionally washing the gel;
performing an anion exchange on the gel with an alkali or alkaline earth metal carbonate, thereby forming sevelamer carbonate;
optionally washing the sevelamer carbonate; and
optionally drying the sevelamer carbonate.
